(19) United States
(12) Patent Application Publication
(10) Pub. No.: US 2015/0126286 A1
(43) Pub. Date: May 7, 2015

(54) Method And System For Implementing Artificial Intelligence

(71) Applicant: Tencent Technology (Shenzhen) Company Limited, Shenzhen (CN)

(72) Inventor: Kangping GUO, Shenzhen (CN)

(21) Appl. No.: 14/597,124

(22) Filed: Jan. 14, 2015

Related U.S. Application Data
(63) Continuation of application No. PCT/CN2014/081384, filed on Jul. 1, 2014.

(30) Foreign Application Priority Data
Sep. 27, 2013 (CN) 201310451071.9

(51) Int. Cl. A63F 13/55

(52) U.S. Cl. CPC A63F 13/55
USPC 463/42

(57) ABSTRACT

A method of implementing artificial intelligence for a non-playing character in a game includes: collecting respective real-user response strategy data associated with each of a plurality of game interactions between two human users, including respective parameter values for a action performed by a respective first human user in a respective game scenario, a respective response performed by a respective second human user in response to the respective action, and a respective outcome of the game interaction; identifying recommended game response types for each of a plurality of possible game action types based on the respective outcomes for the plurality of game interactions; and providing the recommended game response types for each possible game action type for selection by a second device serving as the non-playing character in a game session of the game played between a human user and the non-playing character.

### PRIORITY CLAIM AND RELATED APPLICATIONS

This application is a continuation application of PCT Patent Application No. PCT/CN2014/081384, entitled “METHOD AND SYSTEM FOR IMPLEMENTING ARTIFICIAL INTELLIGENCE” filed on Jul. 1, 2014, which claims priority to Chinese Patent Application No. 201310451071.9, entitled “Method, Server, and Device for Implementing Artificial Intelligence”, filed on Sep. 27, 2013, both of which are incorporated by reference in their entirety.

### TECHNICAL FIELD

The present disclosure relates to the field of computer technologies, and in particular, to a technique for implementing artificial intelligence (AI).

### BACKGROUND

There are different ways to implement AI on computers. One of the ways of implementing AI is by traditional computer programming to make a system appear to possess intelligent in different scenarios, regardless of whether the processes used to implement the artificial intelligence is the same as the processes used by humans or animals. This is the so-called “engineering approach”. This approach has made great achievements in many areas, such as word recognition, computer chess, etc.

If the engineering approach is used to implement AI, detailed program logic is required to specify the “intelligent responses” that is to be provided under various conditions. If parameters describing the different possible scenarios are relatively simple and few in number, the program logic is relatively easy to implement. However, if the parameters describing the different possible scenarios are relatively complex and large in number, the number of AI controls and the memory usage thereof will increase correspondingly, and the corresponding program logic will become very complicated very quickly (e.g., according to exponential growth rate). As a result, the process for implementing artificial intelligence through traditional programming is very tedious, and is error-prone. In addition, once a programming or logic error occurs, the original program needs to be modified, re-complied, and debugged, and a new version or a new patch needs to be provided for the user.

Based on the above deficiencies of the traditional ways of implementing artificial intelligence, a more efficient ways of implementing AI is desirable.

### SUMMARY

In the present disclosure, a method of implementing artificial intelligence, in particular, of implementing artificial intelligence for a non-playing character in a game, is disclosed.

In some embodiments, the method of implementing artificial intelligence for a non-playing character in a game includes: at a first device having one or more processors and memory: collecting respective real-user response strategy data associated with each of a plurality of game interactions between two human users while playing the game, the respective real-user response strategy data for each game interaction including respective parameter values for: a set of action parameters for a respective game action performed by a respective first human user in a respective game scenario, a set of response parameters for a respective game response performed by a respective second human user in the respective game scenario in response to the respective game action performed by the respective first human user, and a set of response outcome parameters for a respective outcome of the game interaction; identifying from the collected real-user response strategy data a respective set of recommended game response types for each of a plurality of possible game action types based at least on the respective values for the set of response outcome parameters for each of the plurality of game interactions; and providing the respective set of recommended game response types for each of the plurality of possible game action types for selection by a second device serving as a non-playing character in a game session of the game played between a human user and the non-playing character.

In some embodiments, a device (e.g., a first device, a second device, etc.) includes one or more processors; and memory storing one or more programs for execution by the one or more processors, wherein the one or more programs include instructions for performing the operations of the methods described herein. In some embodiments, a non-transitory computer readable storage medium stores one or more programs, the one or more programs comprising instructions, which, when executed by an electronic device (e.g., a first device, a second device, etc.) each with one or more processors, cause the electronic device to perform the operations of the methods described herein.

Various other advantages of the various embodiments would be apparent in light of the descriptions below.

### BRIEF DESCRIPTION OF THE DRAWINGS

The aforementioned embodiments as well as additional embodiments will be more clearly understood in light of the following detailed description taken in conjunction with the drawings.

FIG. 1 is a flow chat of an exemplary method for implementing AI in accordance with some embodiments;

FIG. 2 is a flow chat of an exemplary method for implementing AI in accordance with some embodiments;

FIG. 3 is a flow chat of an exemplary method for implementing AI in a game in accordance with some embodiments;

FIG. 4 is a flow chat of an exemplary method for implementing AI in a game in accordance with some embodiments;

FIG. 5 is a block diagram illustrating a server device for implementing AI in accordance with some embodiments;

FIG. 6 is a block diagram illustrating a client device for implementing AI in accordance with some embodiments;

FIG. 7 is a block diagram illustrating a first device for implementing AI in accordance with some embodiments; and

FIG. 8 is a block diagram illustrating a second device for implementing AI in accordance with some embodiments.

Like reference numerals refer to corresponding parts throughout the several views of the drawings.

### DESCRIPTION OF EMBODIMENTS

The present application will be further described in detail by means of embodiments with reference to the drawings, in order to make the technical solution of the present application more clear and understandable. It should be understood that the specific embodiments described here is only for explaining the present application but not for limiting the present application.

In addition to the engineering approach of implementing AI, another method of implementing AI on computers is a modeling approach. The modeling approach not only requires the effect, but also requires that the implementation method should also mimic the process that occurs in humans or living organisms. Generic Algorithm (GA) and Artificial Neural Network (ANN) are both of the modeling approach. The GA models human or biological genetic/evolutionary mechanisms, while the ANN models modes of activity of nerve cells in human or animal brains.

When the modeling approach is adopted, a programmer needs to design an intelligent system (e.g., a module) for each role that is controllable. The intelligent system (e.g., the module) has no knowledge in the beginning just like a newborn baby, but it can learn, and can gradually adapt to the environment, to cope with various complex situations. Such a system often makes mistakes in the beginning, but it can learn from a lesson, and may correct the mistakes when operating the next time. This means that the system at least may not go wrong all the time, and does not require a new version or patch to be released for remedy. Implementing AI with such an approach requires the programmer to think like a biologist, and the learning curve is steep. Once the basic thinking is mastered, this approach can be widely applicable. Since such an approach does not need to specify activity rules of each role in detail during programming, it generally may be more efficient than the engineering approach when applied to complex problems. However, the above scheme requires the programmer to think in a different way, it is a difficult master. Also, this approach requires an AI application device to fail, and then learn from failures, for which the cycle will be very long.

Artificial intelligence has wide applicability, such as controlling machinery and processes in manufacturing, in database or Internet search, in natural language processing, and a machine learning, etc. One of such uses is in electronic gaming that involves a human player controlling one or more game characters to perform various game actions against a computer serving as a non-playing opponent or ally of the human player during game play. The non-playing opponent or ally is a game character that is not currently being controlled by a human player, but may intelligently interact with the game character(s) controlled by a human player during game play. A non-playing character may become a regular character during game play when a human user chooses to control that character during the current game session. When a game character is a non-playing character for the current game session, the game character's behavior is controlled by programming logic. The programming logic generates different actions and responses for the non-playing character based on the current game scenarios and the actions of other characters controlled by real human players. Programming for the non-playing characters using conventional approaches is difficult and time consuming. Each non-playing character requires separate programming, and each time a new game character is added, new programming needs to be implemented for the new game character. For a complex game, there may be a large number of characters for the human user to choose from, and the computer needs to be able to serve as the non-playing opponent or ally using any of the remaining characters. If the programming logic is not sophisticated enough, the non-playing characters will have monotonic and unsophisticated responses, and do not pose sufficient challenge or support to the characters controlled by the human users during game play.

In the present disclosure, a technique for programming non-playing characters in a game alleviates the burden for coming up with the intelligent responses for each game scenario from the game developers. The intelligent responses for a non-playing game character are extracted from game responses performed by game characters controlled by real human users in a large number of game sessions. The environmental parameters that cause the differences in the response strategies of the characters are also extracted from response strategy data generated by real human users. In addition, the probability that a non-playing character uses a particular response strategy is also based on how frequently a real-human user would choose that particular response strategy under the same scenario in a large number of game sessions. In addition, different human users may choose to adopt different response strategies for the same scenarios, most of which may be valid response strategies for the scenario. Extracting these different valid response strategies from the game response strategy data of real human users, and apply them to the game response strategy of non-playing characters may improve the variety in the responses of the non-playing characters. More details of selecting the suitable environmental parameters and the suitable real-user game response strategy data for implementing the response strategy of non-playing characters are disclosed below or will be apparent in light of the disclosure below.

In some embodiments, a method for implementing AI, which also may achieve device learning effects, is illustrated in FIG. 1. In some embodiments, the method is implemented on a server side. On the server side, the server collects the real-user game response strategy data from a large number of user devices on which real human users controls a particular game character in a game. The server uses the collected game response strategy data to determine the valid response strategies for each possible game scenario (e.g., including the game environment, relative positions of the game characters, and the actions of the other game characters, etc.). The server then provides the correspondence relationship between game scenarios and response strategies to user devices for controlling the non-playing characters in the game. In some embodiments, the user device chooses the response action for the non-playing characters based on the correspondence relationships and the current game scenario occurring in the current game session. In some embodiments, the server device chooses the response action for the non-playing characters based on the correspondence relationships and the current game scenario occurring in the current game session, and sends the selected response action to the user device as the response action for the non-playing characters. Although the examples are given in the context of implementing artificial intelligence for non-playing characters in a game, the same approach may be used for other usage cases where artificial intelligence is required of computer-controlled roles, as long as mass data on how real-human users may control the roles under various conditions can be collected.

In some embodiments, the method includes the following steps.

Step 101: Gather control parameters (e.g., real-user game response strategy data) from a plurality of AI application devices (e.g., user devices on which a game is played). In some embodiments, an AI application device refers to a device where an AI controlled object (e.g., a non-playing game character) is located, which generally may be a user device (e.g., a game device). In some embodiments, the control parameters include: environmental attribute parameters, response strategy parameters corresponding to the environmental attribute parameters, and response outcomes. In some embodiments, the environmental attribute parameters include a set of parameters that characterizes a condition or scenario in the current application. The response strategy parameters include a set of parameters that define a response action or reaction performed by a role or roles controlled by real human users. The response outcomes include a set of parameters that define an outcome of a response action under a set of conditions or scenario. The control parameters include the correspondence relationship between respective values for the environmental attribute parameters, the response strategy parameters, and the outcome parameters. For example, the environmental attribute parameters may include environmental attribute parameters (e.g., distance between game characters, current game stage, current game location, current game background, etc.) for a respective game scenario. In some embodiments, the response strategy parameters include a set of response parameters for a respective game response performed by a respective human user in a respective game scenario in response to a game action performed by the computer or another human user. In some embodiments, the action of the computer or other user that triggered the response action of a human user is characterized by a subset of parameters in the environmental attribute parameters. In some embodiments, the action of the computer or other user that triggered the response action of a human user is characterized by a subset of parameters included in the response strategy parameters. In some embodiments, an independent set of parameters is used to characterize the action of the computer or other user that triggered the response action of the human user. In some embodiments, each combination of control parameter values, the response strategy parameter values, and the response outcome define a particular scenario in which a response characterized by the response strategy parameter values is provided by a respective human user under the conditions described by the environmental attribute values, and resulted in an outcome characterized by the response outcome.

In some embodiments, when gathering the control parameters (e.g., respective values of the environmental attribute parameters and corresponding response strategy parameters, and response outcome parameters, the server device first categorizes the control parameters according to the particular data needs. For example, if the goal is to implement the response strategy for a particular type of non-playing characters (e.g., a novice-level role, an expert level role), the control parameters are gathered from human users that control characters of the same or similar characteristics. For example, if the non-playing character is a Kung Fu master, the server device gathers the control data from game sessions in which a human user controls a Kung Fu master level character in various fight scenarios. In some embodiments, it may be required that the during the game sessions, the human player is playing against another human player at the Kung Fu master level, such that the response strategy of both human players in the game can be used in creating the response strategy for the non-playing character. In some embodiments, it does not need to be required that during the game sessions, the human player is playing against another human player at the Kung Fu master level. In such embodiments, the response strategy of the human user is used in creating the response strategy for the non-playing character, the variety of the game scenarios can be improved due to the diversity of the opponents in such embodiments. In general, control parameters for a large number of users are collected, such that the response variety and confidence can be ensured.

In some embodiments, the environmental attribute parameters include at least two types of environmental attribute parameters, namely, predefined static environmental attribute parameters, and predefined variable environmental attribute parameters.

In some embodiments, which environmental attribute parameters may affect the response outcomes is determined through predefinition. In other words, only a subset of all possible environmental attribute parameters may be the controlling environmental attributes, where the remaining environmental attribute parameters do not affect the choice of response strategy and/or the outcome of the response strategy. In some embodiments, an environmental attribute parameter is part of the set of controlling environmental attributes only when the values of the environmental attribute parameter is within a particular value range, and/or when it is concurrently present with another environmental attribute parameter or value range of thereof. In some embodiments, identifying the controlling environmental attributes help to keep the number of parameters for monitoring within a reasonable number suitable for the required device performance and result requirements.

In some embodiments, the unchanged environmental attribute parameters for a game include, for example, background, terrain, and the like, which belong to the environmental attribute parameters that are relatively static and difficult to change. In some embodiments, the variable environmental attribute parameters include: distance, object of manipulation, and the like, which belong to the environmental attribute parameters that may change at any time. Table 1 and Table 2 shows some example static and variable environmental attribute parameters, respectively:

TABLE 1
Example of static environmental attribute parameters

| | Static environmental attribute parameters: |
|---|---|
| 1 | Immovable obstructions (e.g., trees, rocks, rivers, |
| | buildings, etc.) |
| 2 | Map types (e.g., field, city, etc.) |
| 3 | Mode option (low intelligence, high intelligence, etc.) |
| . . . | . . . |
| M | Terrain (e.g., mountains, plains, grasslands, water |
| | surfaces, etc.) |

TABLE 2
Example of variable environmental attribute parameters

| | Variable environmental attribute parameters |
|---|---|
| 1 | Distance from an obstruction |
| 2 | Distance from another controlled object (e.g., another |
| | game character) |
| 3 | Action of another controlled object (e.g., action of an |
| | opponent) |
| 4 | Weather |
| . . . | . . . |
| N | height difference |

In some embodiments, the predefined unchanged environmental attribute parameters and the predefined variable environmental attribute parameters include: predefined unchanged environmental attribute parameters within a set range of a controlled object in the AI application device, and predefined variable environmental attribute parameters within the set range of the controlled object in the AI application device. For example, in some embodiments, if the controlled object is a game character, the unchanged environmental parameters are parameters valid within a current game scene (e.g., number of enemies in the current scene, the current terrain, the number of obstacles within the current game scene, etc.), and the variable environmental parameters are parameters valid within a current game scene (e.g., a current distance between the game character and its opponent(s), the current action of the opponent) and the past 30 seconds (e.g., the previous action of the opponent that cannot be repeated within a recharge period, a nearby bomb that has just been ignited but is now out of the current game screen due to movement of the game character, etc.).

The environmental attribute parameters may have a wide range. For example, the data amount of the environmental attribute parameters in a large map and a smaller map will be completely different, but in terms of the AI controlled object, not all the environmental parameters will affect the AI controlled object, which is in line with the reality. Similarly, noise beyond one kilometer will not affect people, and the hurricane beyond one thousand kilometers will not affect people. Therefore, in order to reduce the number of relevant environmental attribute parameters to match the resource capabilities of terminal hardware devices, keeping the total number of environmental attribute parameters considered to a reasonable number without significant impacting the granularity of the AI control is important. In some embodiments, when a large application map or environment is present, the environmental attribute parameters may be set within a suitable range. Which range is suitable specifically may be set by persons skilled in the art according to performance of hardware resources and the degree of influence of the environmental attribute parameters on the AI controlled objects. In some embodiments, when for application environments whose maps are not large, it is unnecessary to further limit the range of the environmental attribute parameters.

In some embodiments, in addition to limiting the number of environmental attribute parameters based on range (e.g., distance, time, stage, etc.), the environmental attribute parameters that actually affect the validity of a response strategy and/or an outcome of the response strategy can also be extracted based on the collected control parameters. For example, the number of obstacles in the current scene may not matter to the decision of the player for controlling a game character, when the player is actively fighting an enemy in the scene rather than moving through the obstacles. In such a scenario, the level, action, and distance of the enemy are the controlling environmental attributes, while the number of obstacles in the scene is not. In another example scenario, if the user chooses a particular response strategy (e.g., leaping forward with a jump action) for its character to avoid an attack of an opponent, the outcome may be bad for the characters if there is an obstacle in front of the character, while the outcome may be good for the character if there is no obstacle in front of the character. Thus, the outcome of a particular response strategy is also a factor in determining whether an environmental attribute parameter is a controlling environmental attribute parameter. So, in a game scenario where an opponent is attacking the character controlled by the user, the controlling environmental parameters would include positions of obstacles around the character, and this controlling environment attribute can be extracted by noting the different outcomes that may result from the same response strategy.

102: Determine valid response strategy parameters in the response strategy parameters corresponding to the environmental attribute parameters according to the control parameters and a predetermined judgment rule.

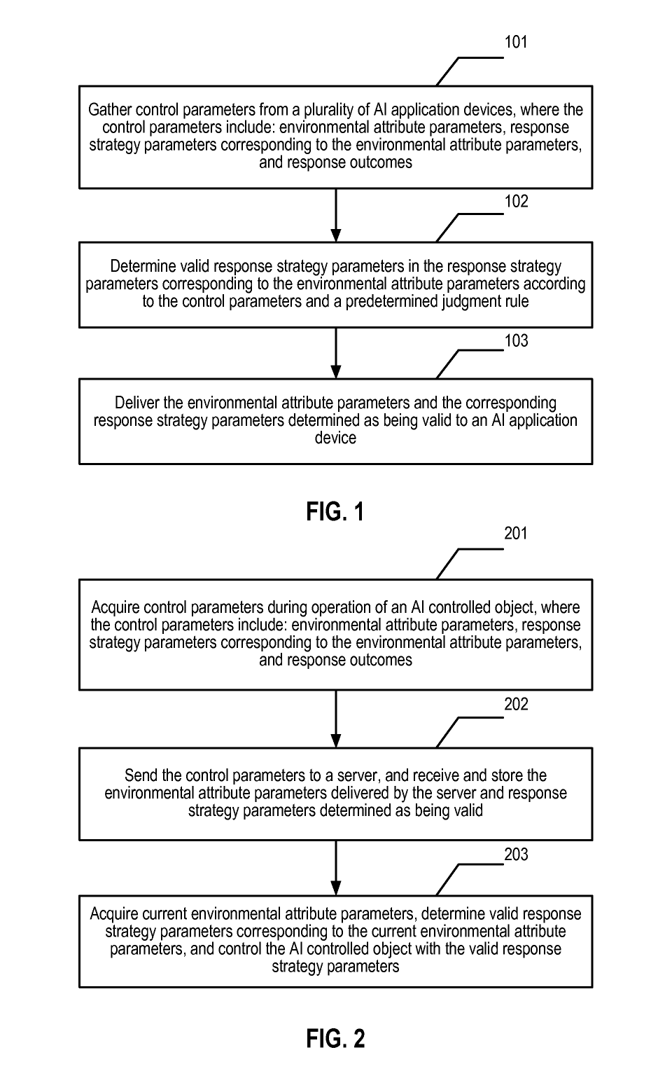

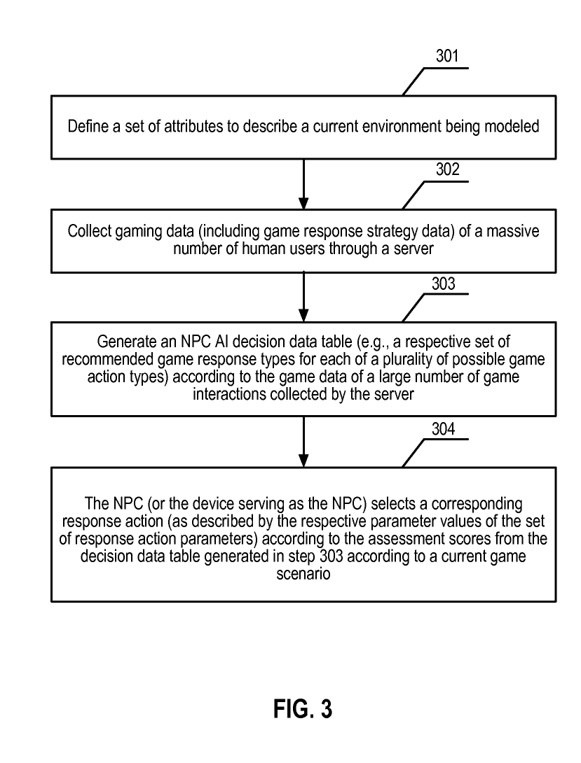

As the response strategy parameters are gathered from a large number of AI application devices, the responses corresponding to the response strategy parameters may not be necessarily valid, and sometimes are even totally invalid or harmful responses for the given situations. As such, these invalid and harmful responses need to be identified and filtered out. Example methods of how to filter out the invalid or harmful response strategies and keep the valid response strategies as the recommended response strategies will be disclosed in more detail with respect to FIG. 2 and FIG. 3.

Step 103: Deliver the environmental attribute parameters and the corresponding response strategy parameters determined as being valid to an AI application device. For example, the AI application device can choose from among the set of response strategies corresponding to a current scenario (e.g., a current scenario with environmental attribute parameter values matching the environmental attribute parameter values corresponding to the set of responses) in controlling an AI controlled object at the AI application device (e.g., a non-playing character controlled by the game executing on a user device).

The above scheme gathers control parameters from a large number of AI application devices for a large number of scenarios and conditions, and screens the control parameters, so as to determine valid response strategy parameters. It aims to have the AI controlled objects learn from real human users, so that the AI controlled objects may exhibit characteristics of intelligence. The scheme does not require a programmer to artificially come up with and specify in detail the actions and control parameters in terms of program logics, which reduces the workload of the developers.

Further, if there are two or more set of valid response strategy parameter values (e.g., corresponding to two or more recommended response strategies) corresponding to a particular set of environmental attribute parameters, the method further includes: determining relative selection priorities of the two or more sets of valid response strategy parameters based on a statistical method, and delivering the selection priorities of the different sets of valid response strategy parameters to the AI application device. The selection priority may be a ranked list with decreasing selection probabilities for the different response strategies represented by the different sets of response strategy parameters.

In some embodiments, the conclusion of the statistical method may be based on respective response outcomes corresponding to each set of the response strategy parameter values. In some embodiments, the conclusion of the statistical method may also be based on a total number of times each particular response strategy has been used by human users among all of the response (or only the valid responses) provided in response to a particular set of environmental attribute parameter values (e.g., representing a particular scenario). In some embodiments, the conclusion of the statistical conclusion may also be based on a total number of each response outcome, and if the response outcome is not unique. In some embodiments, the probability of occurrence of each response outcome will be obtained, that is to say, for each particular scenario, the probability of occurrence of each kind of response outcome will be determined for each possible response strategy adopted for the particular scenario. Thus, each response strategy will have its corresponding set of response outcomes, and each response outcome has an associated probability of occurrence. In some embodiments, the response strategies can be sorted according to their respective response outcomes and the probability of occurrence thereof, so that selection priorities of the response strategies can be obtained.

In some embodiments, the method for implementing AI involves participation of an AI application device, as shown in FIG. 2, which includes the following steps. The AI application device can submit control parameter data to the server device, where the control parameter data are data collected from characters or objects controlled by human users. The AI application device can also receive the response strategy parameters for different possible scenarios from the server, and determine how to control an AI controlled object in future operations. Much of the details of the method performed by the AI application device is apparent in light of the descriptions with respect to the server device.

201: Acquire control parameters (e.g., game response strategy data) during operation of an AI controlled object, where the control parameters include: environmental attribute parameters, response strategy parameters corresponding to the environmental attribute parameters, and response outcomes.

202: Send the control parameters to a server, and receive and store the environmental attribute parameters delivered by the server and response strategy parameters determined as being valid.

203: Acquire current environmental attribute parameters, determine valid response strategy parameters corresponding to the current environmental attribute parameters, and control the AI controlled object with the valid response strategy parameters.

Further, in some embodiments, the method further includes: receiving selection priorities of the valid response strategy parameters from the server.

In some embodiments, in step 203, controlling the AI controlled object with the valid response strategy parameters includes: selecting a response strategy (e.g., a set of response strategy parameter values) from the sets of valid response strategy parameter values according to the respective selection priorities of the different sets of valid response strategy parameter values, and controlling the AI controlled object with the selected set of response strategy parameter values.

The following embodiment will give an example of applications of AI in a modeling program. A modeling object in the modeling program is a character in a fighting game. In order to make the fighting character appear to have human intelligence, the following steps can be performed: first, a set of attributes are defined (e.g., a distance between two characters (self and opponent in the fight), whether the two characters are in facing each other, the action type of the opponent, the action time, attack distance, attack height, remaining health of the two characters, etc.) to describing a current modeling fighting scenario or environment. Then, a scripting language or an AI editor can be used to implement the AI of a Non-Player Character (NPC) in the fighting game. The NPC, as controlled by the AI application device determines the current game scenario and then makes a corresponding move selection (i.e., select a response strategy and takes a response action according to the selected response strategy).

If the NPC's response strategy is hard coded by a programmer, it is very likely that a large amount of work is required to prepare the code to implement the AI of the NPC. In addition, new program logic needs to be created for each time a new character is added to the game. It is also difficult to enumerate a large number of possible environments in the modeling in such a manner, and the NPC made in such a manner has the following shortcomings: e.g., they tend to have a monotonic response to each particular environment modeled, it is difficult to make move combinations, it is difficult to make the moves appear well planned and intelligent, and it is prone to programming errors and loopholes. Therefore, the effect of AI achieved by this kind of coding scheme is not good, and the workload is huge. The method shown in FIG. 3 improves the implementation of AI for an NPC, which includes the following steps.

301: Define a set of attributes to describe a current environment being modeled. For example, the set of attributes include a set of environmental attribute parameters that describe a game scenario and/or environment. A particular set of parameter values for the set of environment attribute parameter describes a particular game scenario or environment, and based on the particular set of parameter values, the player can make decisions regarding how to act. In some embodiments, the set of attribute includes attributes describing the physical environment, the game level, and attributes describing the action of other characters (e.g., the opponent) and the relationships between the other characters and the character played by the user of the AI application device.

Examples of environmental parameter values are shown in Table 3 and example response strategy parameter values are shown in Table 4. As shown in FIG. 3, the set of environmental attribute parameters describing a game scenario includes “the state of the other side” and “a distance between two sides”. Of course, the set of environmental attribute parameters may include more parameters than those shown. For each environmental attribute parameter, there may be one or more different parameter values. For example, for “the state of the other side” parameter, the possible parameter values may be “standing”, “squatting”, and “jumping.” For “a distance between two sides” parameter, the possible parameter values may be “first distance”, “second distance”. In some embodiments, a parameter may be a combination of two sub-parameters. For example, “the distance between two sides” parameter may include a combination of a distance parameter and a location parameter, and the possible parameter values may include a combination of “first distance” and “the other side's edge”, “first distance” and “our side's edge”, “second distance” and “the other side's edge”, “second distance” and “our side's edge”, etc. Each set of environmental attribute parameter values describes a particular scenario in the game for which a response strategy is undertaken by the user for controlling his/her character in the game.

TABLE 3
Environmental attribute parameters

| | The state of | |
|---|---|---|
| | the other side | A distance between two sides |
| 1 | Standing | First distance |
| 2 | Standing | First distance + the other side's edge |
| 3 | Standing | First distance + our side's edge |
| 4 | Standing | Second distance |
| 5 | Standing | Second distance + the other side's edge |
| 6 | Standing | Second distance + our side's edge |
| 7 | Squatting | First distance |
| . . . | | |
| K | Jumping | First distance |

In some embodiments, the response strategy parameters describe a response strategy undertaken by a character in response to being confronted with a particular game scenario (e.g., in a particular physical environment, under particular kinds of attack, having a particular kind of health and skill stats, etc.). In some embodiments, the response strategy parameter is a single parameter “move” that describes a response action type. For example, “punch”, “duck”, “turn”, “jump and turn”, etc. are different possible values for the response strategy parameter. In some embodiments, more than one response strategy parameter is used to describe a response action type, for example, a set of response strategy parameters may be used to describe different aspects of a response action type. For example, a response action type may be defined by two or more basic action types, an action sequence for the two or more basic action types, an action speed, an action target position, an action height, etc. A set of parameter values for the set of response strategy parameters corresponds to a respective response strategy or action. Different combinations of parameter values for the set of response strategy parameters correspond to different response strategy or action. For example, a response strategy may be described by a particular set of response strategy parameter values: “standing→a fast left punch→duck→high jump→heavy right punch, on the left side of the screen, attack opponent's body”. A different set of response strategy parameter values, such as “standing→duck→high jump→heavy kick, on the right side of the screen, attack opponent's head” will describe a different response strategy.

Analogously, the action type of a character that triggers the response action of another character can also be described by a set of action parameters with a respective set of parameter values. In this particular example, the action parameters are described as part of the environmental attribute parameters, but in various embodiments, the action parameters can be separately defined from environmental attribute parameters. For example, in some embodiments, all action parameters are considered controlling and would affect the selection of the response strategy, while only some of the non-action parameters among the environmental attribute parameters are controlling environmental attribute parameters. As such, the identification of the controlling environmental attribute parameters can be performed on non-action parameters only. In some embodiments, some action parameters are also non-controlling, thus, identification of the controlling environmental attribute parameters is performed on all environmental attribute parameters, including the action parameters.

TABLE 4
Response strategy parameters

| | Move |
|---|---|
| 1 | Standing light punch |
| 2 | Standing light foot |
| 3 | Standing heavy punch |
| 4 | Standing heavy foot |
| 5 | Squatting light punch |
| 6 | Squatting light foot |
| 7 | Squatting heavy punch |
| 8 | Squatting heavy foot |
| 9 | Jumping light punch |
| 10 | Jumping light foot |
| 11 | Jumping heavy punch |
| 12 | Jumping heavy foot |
| . . . | . . . |
| K | kth big move |

302: Collect gaming data (including game response strategy data) of a massive number of human users through a server.

In this step, the server may record each move (e.g., an action, and/or a response action) made by game character controlled by a human user in the modeling program, record respective parameter values for the set of environmental attribute parameters at the time the move was made according to the gaming situation. The server also records, at the end of each game or game interaction, the response outcome data corresponding to the move. The response outcome data may be the scores and/or health levels of the characters at the end of the game or immediately after the move is performed. In some embodiments, after each game or each game interaction, if the outcome has a score above a predetermined threshold value, the move is considered to be a valid move under the game circumstance, and is given a non-zero weight in determining a recommended response strategy for the game circumstance for implementing the AI for a non-playing character.

For example, in some embodiments, after any single game or game interaction, if the weight computed according to the following formula is greater than 0, the data in the game or game interaction is recorded as valid sample data:

$$weight = \vert \begin{matrix}\frac{self fighting power}{50} - 3 + \\ min ( 3 , \frac{\begin{matrix}opponent ' s ( initial health - final health ) - \\ self ( initial health - final health )\end{matrix}}{1000} )\end{matrix} \vert$$

A different method for determining whether the response strategy in a game interaction is valid is possible. For example, for different kinds of games, the valid or good response strategies can be identified based on a different formula or criteria.

303: Generate an NPC AI decision data table (e.g., a respective set of recommended game response types for each of a plurality of possible game action types) according to the game data of a large number of game interactions collected by the server.

In some embodiments, an example decision data table is shown in Table 5. In the decision data table, each recommended game response type has a corresponding assessment score, which corresponds to a probability it should be selected in a corresponding game scenario. In general, the higher the assessment score is, the greater the advantage of taking the action is in the corresponding game scenario. In addition, the higher the assessment score is, the greater number of people would choose to take the action in the corresponding game scenario. As shown in Table 5, the state of the other side and the distance between two sides are the relevant or controlling environmental attribute parameters that have been identified. For each set of parameter values for the set of environmental attribute parameters, respective parameter values for a set of response action parameters describing a respective response action type (noted as our sides' action) are specified. For example, for a game scenario with the opponent having a squatting state and located at a first distance away from the character, the respective parameter values for a corresponding recommended response action type includes a sequence of moves “dfu”. In some embodiments, the assessment score for the recommended response action type is calculated based on the total number of times that response strategy has been used among all of the collected gamin data for all game interactions (or alternatively, among all of the collected gaming data for game interactions in which the game scenario is present). In some embodiments, when calculating the assessment score, the count of each sample data (i.e., 1 for each instance in which the response strategy is used for the gaming scenario in a game interaction) is weighted by the weight calculated based on response outcome recorded for the game interaction. Since the response outcome is not always deterministic for a particular response action and a corresponding game scenario, the weight takes into account of the likelihood that each kind of response outcomes may occur for the response action and corresponding game scenario. This way, the assessment score not only takes into account how likely a human user may choose a particular response strategy under a given game scenario, but also how well the response strategy may work under the given game scenario.

TABLE 5
Decision data table

| State of | Distance | Our | |
|---|---|---|---|
| the other | between | side's | |
| side | two sides | action | Assessment Score |
| Standing | First distance | j | Σ the number of each single |
| | | | game × single game weight |
| Standing | First distance + | k | Σ the number of each single |
| | the other side's edge | | game × single game weight |
| Standing | First distance + | u | Σ the number of each single |
| | our side's edge | | game × single game weight |
| Standing | Second distance | i | Σ the number of each single |
| | | | game × single game weight |
| Standing | Second distance + | dfj | Σ the number of each single |
| | the other side's edge | | game × single game weight |
| Standing | Second distance + | dfk | Σ the number of each single |
| | our side's edge | | game × single game weight |
| Squatting | First distance | dfu | Σ the number of each single |
| | | | game × single game weight |
| . . . | . . . | . . . | . . . |
| Jumping | First distance | sasdj | Σ the number of each single |
| | | | game × single game weight |

304: In actual applications of the AI for a NPC in a game, the NPC (or the device serving as the NPC) selects a corresponding response action (as described by the respective parameter values of the set of response action parameters) according to the assessment scores from the decision data table generated in step 303 according to a current game scenario (e.g., by respective parameter values for the set of environmental attribute parameters that describe the current gaming scenario).

In some embodiments, the probability of a particular response strategy to be selected for the NPC is based on the assessment score of the particular response strategy divided by the sum of the assessment scores of all recommended response strategies for the scenario (or all possible response strategies). In general, the higher the assessment score of the response strategy is, the better the response strategy may perform under the circumstance, and the greater the probability that the response strategy is selected should be.

Through the above four steps, the purpose that the NPC learns from fighting actions of real human users can be achieved, and the actions taken by the NPC would be the correct responses that a great number of human users would take in the corresponding scenarios being modeled in the program environments. For the NPC AI implemented in this manner, if there is a new controlled object (e.g., a new game character) being added to the game, it is only necessary for the server to automatically collect the game response strategy data from a large number of users, and through statistics generate a decision data table for the new controlled object, and thus, it is quite convenient to implement the AI of the new controlled object. As the number of the collected samples is great and each data sample is assessed by scoring, actions selected by the NPC have characteristics of diversity and intelligence. In addition, when choosing the game strategy response data to include into the sample corpus, the server optionally filters the collected game strategy response data based on the characteristics of the new NPC, such that the game response strategy data from characters resembling the new NPC are used. In some embodiments, the new NPC has the characteristics of multiple existing characters in the current game or other games, the game response strategy data from these multiple characters in the current game or other games may be collected and used to implement the response strategy for the new NPC.

The techniques described in the present disclosure collects massive amount of real-user game response strategy data (e.g., action, response, game scenario, response outcome data of game interactions involving characters controlled by human users) at a server, assesses the response strategy data by scoring, and finally obtains through statistics an NPC AI decision data table. Thus, the implementation of the NPC AI does not rely on compiling a great number of program code and scripts, and the NPC may learn the correct response strategies from real human users, to achieve diversity and intelligence of the NPC's response for different conditions and environments.

Although the above example is given in the context of implementing AI for an NPC in a game, it should be noted that, as long as AI schemes are applied to a usage case involving actions by human users at a plurality of terminals, the technique disclosed herein can be used to implement the AI of other objects analogous to those controlled by the human users.

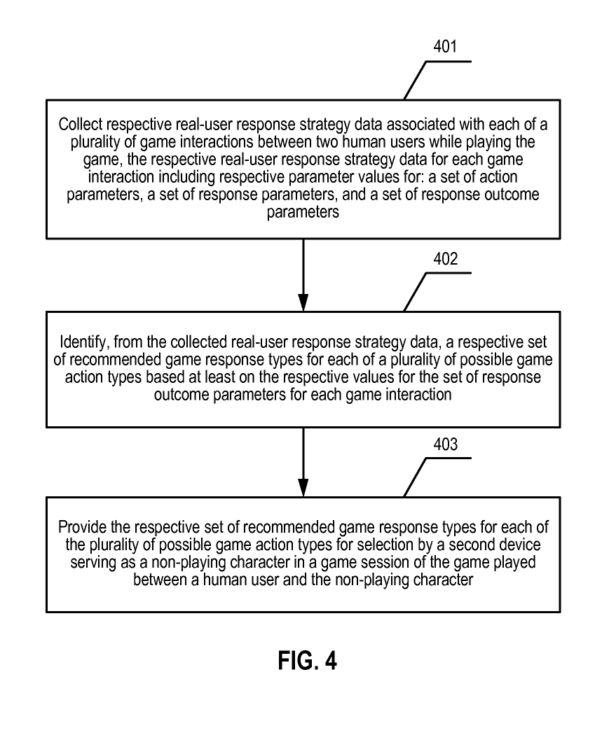

As shown in FIG. 4, based on the above examples and descriptions, in some embodiments, a method of implementing AI in a game includes the following steps. In some embodiments, the method is performed at a first device (e.g., a server), and the AI is implemented for controlling a non-playing character (NPC) at a second device (e.g., a game client device).

Step 401: Collect respective real-user response strategy data associated with each of a plurality of game interactions between two human users while playing the game, the respective real-user response strategy data for each game interaction including respective parameter values for: a set of action parameters for a respective game action performed by a respective first human user in a respective game scenario, a set of response parameters for a respective game response performed by a respective second human user in the respective game scenario in response to the respective game action performed by the respective first human user, and a set of response outcome parameters for a respective outcome of the game interaction.

Step 402: Identify, from the collected real-user response strategy data, a respective set of recommended game response types for each of a plurality of possible game action types based at least on the respective values for the set of response outcome parameters for each of the plurality of game interactions.

Step 403: Provide the respective set of recommended game response types for each of the plurality of possible game action types for selection by a second device serving as a non-playing character in a game session of the game played between a human user and the non-playing character.

In some embodiments, the respective real-user response strategy data for each of the plurality of game interactions further includes respective parameter values for a set of environmental attribute parameters for a respective game scenario in which the game interaction has occurred, and the server device further identifies, from the set of environmental attribute parameters, a respective set of controlling environmental attributes for a first possible game action type of the plurality of possible game action types, based at least on the respective values for the set of response parameters for a first plurality of game responses included in the collected real-user response strategy data, where the first plurality of game responses have been performed in response to respective game actions of the first possible game action type.

In some embodiments, the server determines a respective selection priority for each of the respective set of recommended game response types for a first possible game action type of the plurality of possible game action types, based at least on the respective values for the set of response outcome parameters associated with the respective game actions of the first possible game action type found in the collected real-user response strategy data.

In some embodiments, the server determines a respective selection priority for each of the respective set of recommended game response types for a first possible game action type of the plurality of possible game action types, based at least on a total number of times that the recommended game response type is used by a respective human user when responding to the respective game actions of the first possible game action type, as recorded in the collected real-user response strategy data.

In some embodiments, when providing the respective set of recommended game response types for each of the plurality of possible game action types for selection by a second device, the server provides, with each recommended game response type for each possible game action type, a corresponding game scenario type defining a respective game scenario in which said each recommended game response type is available for selection by the second device to generate a response to a game action of said each possible game action type.

In some embodiments, when providing the respective set of recommended game response types for each of the plurality of possible game action types for selection by a second device, the server provides, with each recommended game response type for each possible game action type, a corresponding selection priority defining a respective probability by which said each recommended game response type is to be selected by the second device to generate a response to a game action of said each possible game action type.

In some embodiments, the game is a fighting game and each game interaction includes one or more offense moves and one or more counter moves in a single exchange between two players. In some embodiments, the non-playing character is a new character added to an updated version of the game after the collection of the game response strategy data.

Other details of the above method are provided with respect to FIGS. 1-3, and accompanying descriptions and are not repeated in the interest of brevity.

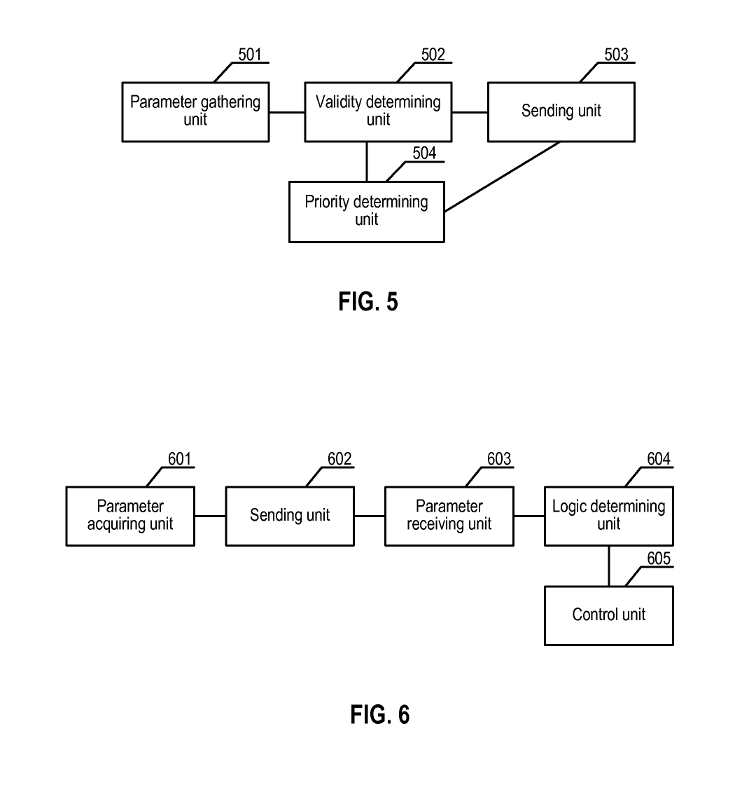

FIG. 5 is a block diagram illustrating a device for implementing artificial intelligence of a controlled object. For example, the device may be a server device that collects real-user control data from a large number of user devices operated by human users.

In some embodiments, the device includes:

A parameter gathering unit 501, for gathering control parameters from a plurality of AI application devices, where the control parameters include: environmental attribute parameters, response strategy parameters corresponding to the environmental attribute parameters and response outcomes;

A validity determining unit 502, for determining valid response strategy parameters in the response strategy parameters corresponding to the environmental attribute parameters according to the control parameters gathered by the parameter gathering unit 401 and a predetermined judgment rule; and

A sending unit 503, for delivering the environmental attribute parameters and the response strategy parameters determined as being valid by the validity determining unit 402 to an AI application device.

In some embodiments, the device further includes:

A priority determining unit 504, for, if the validity determining unit 502 determines that there are two or more valid response strategy parameters corresponding to the environmental attribute parameters, determining selection priorities of the valid response strategy parameters based on an outcome of a statistical evaluation.

In some embodiments, the sending unit 503 is further used for delivering the selection priorities of the valid response strategy parameters to the AI application device.

FIG. 6 is a block diagram illustrating a device for implementing artificial intelligence of a controlled object. For example, the device may be an AI application device that sends the real-user control data to a server device, receives valid response strategy parameters from the server, and control an AI-controlled object based on the received valid response strategy parameters. In some embodiments, the device includes:

A parameter acquiring unit 601, for acquiring control parameters during operation of a human controlled object (e.g., a game character that is controlled by a human user, and that is similar or identical to a character for which AI is to be implemented), where the control parameters include: environmental attribute parameters, response strategy parameters corresponding to the environmental attribute parameters and response outcomes; and acquiring the current environmental attribute parameters;

A sending unit 602, for sending the control parameters acquired by the parameter acquire unit 601 to a server;

A parameter receiving unit 603, for receiving and storing the environmental attribute parameters delivered by the server and response strategy parameters determined as being valid;

A logic determining unit 604, for determining valid response strategy parameters corresponding to the current environmental attribute parameters; and

A control unit 605, for controlling an AI controlled object with the valid response strategy parameters determined by the logic determining unit 604.

In some embodiments, the parameter receiving unit 603 is further used for receiving selection priorities of the valid response strategy parameters; and the control unit 605 is used for selecting a response strategy parameter from the valid response strategy parameters according to the selection priorities of the valid response strategy parameters, and controlling the AI controlled object with the selected response strategy parameter.

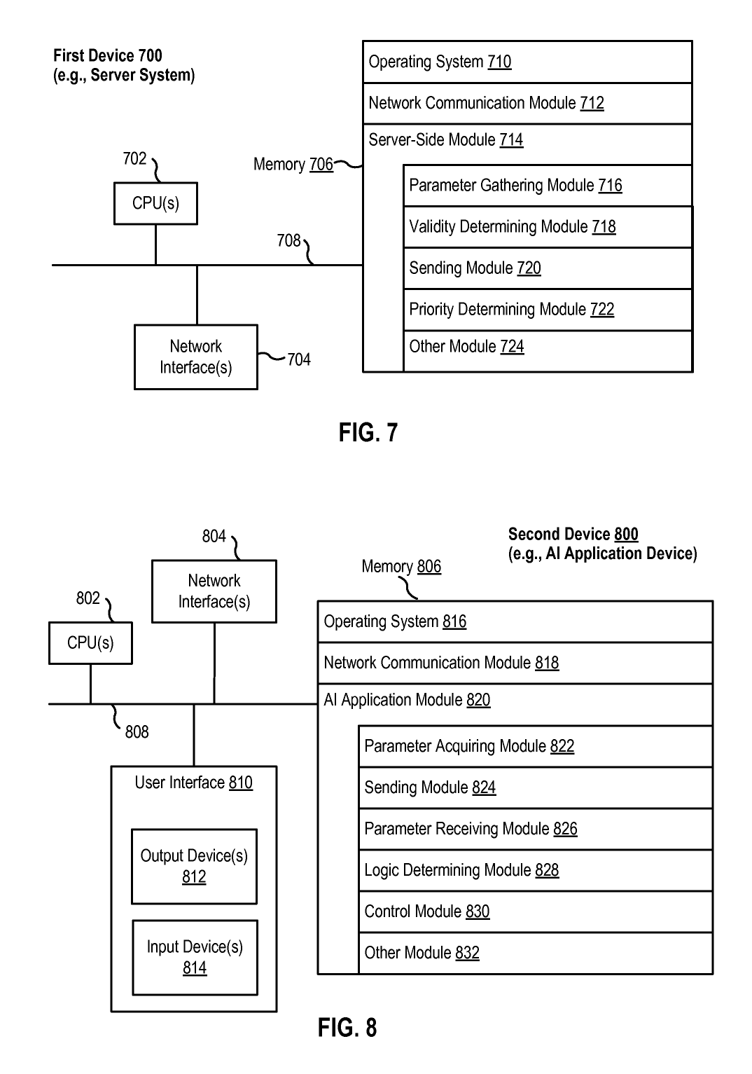

FIG. 7 is a block diagram illustrating a first device 700 (e.g., a server system) in accordance with some embodiments. Server system 700, typically, includes one or more processing units (CPUs) 702, one or more network interfaces 704 (e.g., including I/O interface to the second device 800), memory 706, and one or more communication buses 708 for interconnecting these components (sometimes called a chipset). Memory 706 includes high-speed random access memory, such as DRAM, SRAM, DDR RAM, or other random access solid state memory devices; and, optionally, includes non-volatile memory, such as one or more magnetic disk storage devices, optical disk storage devices, flash memory devices, or other non-volatile solid state storage devices. Memory 706, optionally, includes one or more storage devices remotely located from the CPU(s) 712. Memory 706, or alternately the non-volatile memory device(s) within memory 706, includes a non-transitory computer readable storage medium. In some implementations, memory 706, or the non-transitory computer readable storage medium of memory 706, stores the following programs, modules, and data structures, or a subset or superset hereof:
an operating system 710 including procedures for handling various basic system services and for performing hardware dependent tasks;
a network communication module 712 that is used for connecting first device 700 to other computing devices (e.g., the second device 800) connected to one or more networks via one or more network interfaces 704 (wired or wireless);
a server-side module 708 for performing data processing for implementing AI as disclosed herein, including but not limited to:
   a parameter gathering module 716 for gathering control parameters from a plurality of AI application devices;
   a validity determining module 718, for determining valid/recommended response strategy parameters corresponding to different environmental control parameters according to the control parameters gathered by the parameter gathering module 716 and a predetermined judgment rule;
   a sending module 720, for delivering the environmental attribute parameters and the response strategy parameters determined as being valid/recommended by the validity determining module 718 to an AI application device; and
   a priority determining module 722, for, if the validity determining module 718 determines that there are two or more valid response strategy parameters corresponding to the environmental attribute parameters, determining selection priorities of the valid response strategy parameters based on an outcome of a statistical evaluation. In some embodiments, the sending module 720 is further used for delivering the selection priorities of the valid response strategy parameters to the AI application device; and
   other modules, for performing other functions of the first device as described herein.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, memory 706, optionally, stores a subset of the modules and data structures identified above. Furthermore, memory 706, optionally, stores additional modules and data structures not described above.

FIG. 8 is a block diagram illustrating a second device 800 (e.g., an AI application device) in accordance with some embodiments. The second device 800, typically, includes one or more processing units (CPUs) 802, one or more network interfaces 804, memory 806, and one or more communication buses 808 for interconnecting these components (sometimes called a chipset). The second device 800 also includes a user interface 810. User interface 810 includes one or more output devices 812 that enable presentation of media content, including one or more speakers and/or one or more visual displays. User interface 810 also includes one or more input devices 814, including user interface components that facilitate user input such as a keyboard, a mouse, a voice-command input unit or microphone, a touch-screen display, a touch-sensitive input pad, a gesture capturing camera, or other input buttons or controls. Memory 806 includes high-speed random access memory, such as DRAM, SRAM, DDR RAM, or other random access solid state memory devices; and, optionally, includes non-volatile memory, such as one or more magnetic disk storage devices, optical disk storage devices, flash memory devices, or other non-volatile solid state storage devices. Memory 806, optionally, includes one or more storage devices remotely located from CPU(s) 802. Memory 806, or alternately the non-volatile memory device(s) within memory 806, includes a non-transitory computer readable storage medium. In some implementations, memory 806, or the non-transitory computer readable storage medium of memory 806, stores the following programs, modules, and data structures, or a subset or superset thereof:
an operating system 816 including procedures for handling various basic system services and for performing hardware dependent tasks; and
a network communication module 818 for connecting the second device 800 to other computing devices (e.g., first device 700) connected to one or more networks via one or more network interfaces 804 (wired or wireless).

In some embodiments, memory 806 also includes an AI application module 820 (e.g., a gaming module) for running an AI application. AI application module 820 includes, but is not limited to:
a parameter acquiring module 822, for acquiring control parameters during operation of a human controlled object (e.g., a game character that is controlled by a human user, and that is similar or identical to a character for which AI is to be implemented);
a sending module 824, for sending the control parameters acquired by the parameter acquire module 822 to a first device;
a parameter receiving module 826, for receiving and storing the environmental attribute parameters delivered by the first device and response strategy parameters determined as being valid;
a logic determining module 828, for determining valid response strategy parameters corresponding to the current environmental attribute parameters;
a control module 830, for controlling an AI controlled object with the valid response strategy parameters determined by the logic determining module 828. In some embodiments, the parameter receiving module 826 is further used for receiving selection priorities of the valid response strategy parameters; and the control module 830 is used for selecting a response strategy parameter from the valid response strategy parameters according to the selection priorities of the valid response strategy parameters, and controlling the AI controlled object with the selected response strategy; and
other modules, for performing other functions of the second device as described herein.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, memory 806, optionally, stores a subset of the modules and data structures identified above. Furthermore, memory 806, optionally, stores additional modules and data structures not described above.

While particular embodiments are described above, it will be understood it is not intended to limit the present application to these particular embodiments. On the contrary, the present application includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

What is claimed is:

1. A method of implementing artificial intelligence for a non-playing character in a game:
at a first device having one or more processors and memory:
collecting respective real-user response strategy data associated with each of a plurality of game interactions between two human users while playing the game, the respective real-user response strategy data for each game interaction including respective parameter values for: (1) a set of action parameters for a respective game action performed by a respective first human user in a respective game scenario, (2) a set of response parameters for a respective game response performed by a respective second human user in the respective game scenario in response to the respective game action performed by the respective first human user, and (3) a set of response outcome parameters for a respective outcome of the game interaction;
identifying, from the collected real-user response strategy data, a respective set of recommended game response types for each of a plurality of possible game action types based at least on the respective values for the set of response outcome parameters for each of the plurality of game interactions; and
providing the respective set of recommended game response types for each of the plurality of possible game action types for selection by a second device serving as a non-playing character in a game session of the game played between a human user and the non-playing character.

2. The method of claim 1, wherein the respective real-user response strategy data for each of the plurality of game interactions further comprises respective parameter values for a set of environmental attribute parameters for a respective game scenario in which the game interaction has occurred, and wherein the method further comprises:
identifying, from the set of environmental attribute parameters, a respective set of controlling environmental attributes for a first possible game action type of the plurality of possible game action types, based at least on the respective values for the set of response parameters for a first plurality of game responses included in the collected real-user response strategy data, wherein the first plurality of game responses have been performed in response to respective game actions of the first possible game action type.

3. The method of claim 1, further comprising:
determining a respective selection priority for each of the respective set of recommended game response types for a first possible game action type of the plurality of possible game action types, based at least on the respective values for the set of response outcome parameters associated with the respective game actions of the first possible game action type found in the collected real-user response strategy data.

4. The method of claim 1, further comprising:
determining a respective selection priority for each of the respective set of recommended game response types for a first possible game action type of the plurality of possible game action types, based at least on a total number of times that the recommended game response type is used by a respective human user when responding to the respective game actions of the first possible game action type, as recorded in the collected real-user response strategy data.

5. The method of claim 1, wherein providing the respective set of recommended game response types for each of the plurality of possible game action types for selection by a second device further comprises:
providing, with each recommended game response type for each possible game action type, a corresponding game scenario type defining a respective game scenario in which said each recommended game response type is available for selection by the second device to generate a response to a game action of said each possible game action type.

6. The method of claim 1, wherein providing the respective set of recommended game response types for each of the plurality of possible game action types for selection by a second device further comprises:
providing, with each recommended game response type for each possible game action type, a corresponding selection priority defining a respective probability by which said each recommended game response type is to be selected by the second device to generate a response to a game action of said each possible game action type.

7. The method of claim 1, wherein the game is a fighting game and each game interaction includes one or more offense moves and one or more counter moves in a single exchange between two players.

8. The method of claim 1, wherein the non-playing character is a new character added to an updated version of the game after the collection of the game response strategy data.

9. A system for implementing artificial intelligence for a non-playing character in a game, the system comprising:
one or more processors; and
memory having instructions stored thereon, the instructions, when executed by the one or more processors, cause the processors to perform operations comprising:
collecting respective real-user response strategy data associated with each of a plurality of game interactions between two human users while playing the game, the respective real-user response strategy data for each game interaction including respective parameter values for: (1) a set of action parameters for a respective game action performed by a respective first human user in a respective game scenario, (2) a set of response parameters for a respective game response performed by a respective second human user in the respective game scenario in response to the respective game action performed by the respective first human user, and (3) a set of response outcome parameters for a respective outcome of the game interaction;
identifying, from the collected real-user response strategy data, a respective set of recommended game response types for each of a plurality of possible game action types based at least on the respective values for the set of response outcome parameters for each of the plurality of game interactions; and
providing the respective set of recommended game response types for each of the plurality of possible game action types for selection by an application device serving as a non-playing character in a game session of the game played between a human user and the non-playing character.

10. The system of claim 9, wherein the respective real-user response strategy data for each of the plurality of game interactions further comprises respective parameter values for a set of environmental attribute parameters for a respective game scenario in which the game interaction has occurred, and wherein the operations further comprise:
identifying, from the set of environmental attribute parameters, a respective set of controlling environmental attributes for a first possible game action type of the plurality of possible game action types, based at least on the respective values for the set of response parameters for a first plurality of game responses included in the collected real-user response strategy data, wherein the first plurality of game responses have been performed in response to respective game actions of the first possible game action type.

11. The system of claim 9, wherein the operations further comprise:
determining a respective selection priority for each of the respective set of recommended game response types for a first possible game action type of the plurality of possible game action types, based at least on the respective values for the set of response outcome parameters associated with the respective game actions of the first possible game action type found in the collected real-user response strategy data.

12. The system of claim 9, wherein the operations further comprise:
determining a respective selection priority for each of the respective set of recommended game response types for a first possible game action type of the plurality of possible game action types, based at least on a total number of times that the recommended game response type is used by a respective human user when responding to the respective game actions of the first possible game action type, as recorded in the collected real-user response strategy data.

13. The system of claim 9, wherein providing the respective set of recommended game response types for each of the plurality of possible game action types for selection by a second device further comprises:
providing, with each recommended game response type for each possible game action type, a corresponding game scenario type defining a respective game scenario in which said each recommended game response type is available for selection by the second device to generate a response to a game action of said each possible game action type.

14. The system of claim 9, wherein providing the respective set of recommended game response types for each of the plurality of possible game action types for selection by a second device further comprises:
providing, with each recommended game response type for each possible game action type, a corresponding selection priority defining a respective probability by which said each recommended game response type is to be selected by the second device to generate a response to a game action of said each possible game action type.

15. The system of claim 9, wherein the game is a fighting game and each game interaction includes one or more offense moves and one or more counter moves in a single exchange between two players.

16. The system of claim 9, wherein the non-playing character is a new character added to an updated version of the game after the collection of the game response strategy data.

17. A non-transitory computer-readable medium having instructions stored thereon, the instructions, when executed by one or more processors, cause the processors to perform operations comprising:
collecting respective real-user response strategy data associated with each of a plurality of game interactions between two human users while playing a game, the respective real-user response strategy data for each game interaction including respective parameter values for: (1) a set of action parameters for a respective game action performed by a respective first human user in a respective game scenario, (2) a set of response parameters for a respective game response performed by a respective second human user in the respective game scenario in response to the respective game action performed by the respective first human user, and (3) a set of response outcome parameters for a respective outcome of the game interaction;
identifying, from the collected real-user response strategy data, a respective set of recommended game response types for each of a plurality of possible game action types based at least on the respective values for the set of response outcome parameters for each of the plurality of game interactions; and
providing the respective set of recommended game response types for each of the plurality of possible game action types for selection by an application device serving as a non-playing character in a game session of the game played between a human user and the non-playing character.

18. The computer-readable medium of claim 17, wherein the respective real-user response strategy data for each of the plurality of game interactions further comprises respective parameter values for a set of environmental attribute parameters for a respective game scenario in which the game interaction has occurred, and wherein the operations further comprise:
identifying, from the set of environmental attribute parameters, a respective set of controlling environmental attributes for a first possible game action type of the plurality of possible game action types, based at least on the respective values for the set of response parameters for a first plurality of game responses included in the collected real-user response strategy data, wherein the first plurality of game responses have been performed in response to respective game actions of the first possible game action type.

19. The computer-readable medium of claim 17, wherein the operations further comprise:
determining a respective selection priority for each of the respective set of recommended game response types for a first possible game action type of the plurality of possible game action types, based at least on the respective values for the set of response outcome parameters associated with the respective game actions of the first possible game action type found in the collected real-user response strategy data.

20. The computer-readable medium of claim 17, wherein the operations further comprise:
determining a respective selection priority for each of the respective set of recommended game response types for a first possible game action type of the plurality of possible game action types, based at least on a total number of times that the recommended game response type is used by a respective human user when responding to the respective game actions of the first possible game action type, as recorded in the collected real-user response strategy data.
